(19) United States
(12) Patent Application Publication
(10) Pub. No.: US 2004/0263503 A1
(43) Pub. Date: Dec. 30, 2004

(54) Drive devices and drive methods for light emitting display panel

(75) Inventor: Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/862,406

(22) Filed: Jun. 8, 2004

(30) Foreign Application Priority Data
Jun. 24, 2003 (JP) 2003-179237

(51) Int. Cl. G09G 5/00; H01J 1/62; G06T 11/20

(52) U.S. Cl. 345/204; 345/443

(57) ABSTRACT

An active matrix type EL display device is constructed in such a way that a reverse bias voltage can be effectively applied to an EL element without decreasing the lighting time rate thereof. An EL element E1 constituting one pixel 10 is driven to be lit by a write transistor Tr1 and a driving transistor Tr2 and the lighting time of the EL element is controlled by an erase transistor Tr3 so that a multi-gradation expression is realized. The drain of a reverse bias applying transistor is connected to the anode terminal of the EL element E1, and the gate and the source of the same transistor Tr4 are connected to the respective gates of the erase transistor Tr3 and the write transistor Tr1, respectively. By this structure, an ON operation of the reverse bias applying transistor Tr4 is implemented in synchronization with an ON operation of the erase transistor Tr3 so that a reverse bias voltage can be supplied to the EL element E1.

### BACKGROUND OF THE INVENTION

1. Field of the Invention

The present invention relates to drive devices for a light emitting display panel in which light emitting elements constituting pixels are actively driven by for example TFTs (thin film transistors), and particularly to drive devices and drive methods for a light emitting display panel in which a reverse bias voltage can be effectively applied to a light emitting element without decreasing a lighting time rate (light emission duty ratio) of the light emitting element.

2. Description of the Related Art

A display employing a display panel which is constructed by arranging light emitting elements in a matrix pattern has been developed widely. As the light emitting element employed in such a display panel, an organic EL (electroluminescent) element in which for example an organic material is employed in a light emitting layer has attracted attention, and such a display has already been commercialized in part of products. This is because of backgrounds one of which is that by employing, in the light emitting layer of the EL element, an organic compound which enables an excellent light emitting characteristic to be expected, a high efficiency and a long life which make an EL element satisfactorily practicable have been achieved.

As a display panel employing such organic EL elements, a passive matrix type display device in which EL elements are simply arranged in a matrix pattern and an active matrix type display device in which respective active elements for example constituted by TFTs are added to respective EL elements arranged in a matrix pattern have been proposed. The latter active matrix type display panel has special properties that low power consumption can be realized compared to the former passive matrix type display panel, that crosstalk between pixels is small, and the like, thereby particularly being suitable for a high-precision display constituting a large screen.

FIG. 1 shows one example of a circuit structure corresponding to one pixel 10 in an active matrix type display panel which has already been proposed. In FIG. 1, the gate G of a control TFT, that is, a write transistor Tr1, is connected to a scan line (scan line A1), and the source S thereof is connected to a data line (data line B1). The drain D of this write transistor Tr1 is connected to the gate G of a lighting driving TFT, that is, a driving transistor Tr2, and to one terminal of an electrical charges maintaining capacitor C1.

The source S of the driving transistor Tr2 is connected to the other terminal of the capacitor C1 and to a common anode 11 formed in the panel. The drain D of the driving transistor Tr2 is connected to the anode of an organic EL element E1, and the cathode terminal of this organic EL element E1 is connected to a common cathode 12, for example constituting a reference electrical potential point (ground), formed in the panel.

FIG. 2 schematically shows a state in which the circuit structures each of which bears the pixel 10 shown in FIG. 1 are arranged on a display panel 15, and each pixel 10 of the circuit structure shown in FIG. 1 is formed respectively at respective crossing positions between respective scan lines Al to An and respective data lines B1 to Bm. In this structure, each source S of the driving transistor Tr2 is connected to the common anode 11 shown in FIG. 2 respectively, and the cathode terminal of each EL element E1 is connected respectively to the common cathode 12 shown in FIG. 2 similarly. Further, in this circuit, in a case where light emission control is implemented, a positive power source terminal of a voltage source V1 is connected to the common anode 11 formed in the display panel 15 via a switch 14, and a negative power source terminal of the voltage source V1 is connected to the common cathode 12.

In this state, when an ON voltage is supplied to the gate G of the write transistor Tr1 in FIG. 1 via a scan line, the transistor Tr1 allows current corresponding to a voltage supplied from a data line to the source S to flow from the source S to the drain D. Accordingly, during the period in which the gate G of the transistor Tr1 is the ON voltage, the capacitor C1 is charged, and the voltage thereof is supplied to the gate G of the transistor Tr2 so that current based on the gate voltage and the source voltage of the transistor Tr2 flows from the source S to the common cathode 12 through the EL element E1, whereby the EL element E1 emit light.

When the gate G of the transistor Tr1 becomes an OFF voltage, the transistor Tr1 becomes a so-called cutoff, and the drain D of the transistor Tr1 becomes in an open state. However, the voltage of the gate G of the driving transistor Tr2 is maintained by electrical charges accumulated in the capacitor C1, and drive current is maintained until the next scan, so that the light emission of the EL element E1 is maintained. Since gate input capacitance exits in the driving transistor Tr2, even when the capacitor C1 is not provided particularly, an operation similar to the above can be performed.

It has been known that the organic EL element electrically has a light emission element having a diode characteristic and a static capacitance (parasitic capacitance) connected in parallel thereto and that the organic EL element emits light whose intensity is approximately proportional to the forward current of this diode characteristic. Further, with respect to the EL element, it has been known empirically that by successively applying a voltage of a reverse direction (reverse bias voltage) which does not participate in light emission, crosstalk light emission can be reduced and the light emission life of an EL element can be prolonged. For example Japanese Patent Application Laid-Open No. 2001-117534 (paragraphs 0014 to 0016 and 0020 and FIGS. 6 and 8) shown below discloses that a reverse bias voltage is applied between the common anode 11 and the common cathode 12.

The above-mentioned FIG. 1 shows the structure shown in FIG. 6 in Japanese Patent Application Laid-Open No. 2001-117534 (paragraphs 0014 to 0016 and 0020 and FIGS. 6 and 8), and the above-mentioned FIG. 2 shows the structure shown in FIG. 8 in Japanese Patent Application Laid-Open No. 2001-117534 (paragraphs 0014 to 0016 and 0020 and FIGS. 6 and 8). A voltage source V2 in FIG. 2 is utilized when a reverse bias voltage is applied to the EL element E1. That is, when the reverse bias voltage is applied, the switch 14 is switched to the voltage source V2 side. Thus, the positive power source terminal and the negative power source terminal of the voltage source V2 are connected to the common cathode 12 and the common anode 11, respectively. Accordingly, the reverse bias voltage is applied to the EL element E1 shown in FIG. 1 through the drain D and the source D of the driving transistor Tr2.

With the structure of FIGS. 1 and 2 which is shown in Japanese Patent Application Laid-Open No. 2001-117534 (paragraphs 0014 to 0016 and 0020 and FIGS. 6 and 8), since the EL element E1 is connected between the common anode 11 and the common cathode 12 via the driving transistor Tr2, when the reverse bias voltage is applied to the EL element E1, a period in which all EL elements are not lit temporarily has to be set. Thus, in the example disclosed in Japanese Patent Application Laid-Open No. 2001-117534 (paragraphs 0014 to 0016 and 0020 and FIGS. 6 and 8), in a case where a time division gradation expression method is utilized, control is performed so that a period (Tb) in which the reverse bias voltage is applied to all EL elements simultaneously is set during a lighting period of EL elements in a first subfield (SF1) which begins at the time of completion of an address period in which sending a scan signal to all scan lines is completed.

Since a non-lighting time for applying the reverse bias voltage to EL elements is set separately from setting of a lighting time and a non-lighting time of EL elements for performing gradation expression, it cannot be avoided that light emission duty ratio of EL elements, that is, lighting time rate, is decreased. As a result, since substantial light emission intensity of EL elements is decreased, in order to compensate this decrease, necessity of increasing drive current of when EL elements emit light occurs, and a problem that light emission life of EL elements is shortened occurs.

With the above-described applying operation of the reverse bias voltage, since switching operation of a positive voltage and a reverse bias voltage is performed simultaneously for respective circuits including EL elements corresponding to all pixels and capacitors carrying out a voltage maintaining function, it cannot be avoided that load current extremely increases at a moment of the switching. Thus, a countermeasure for a large amount of load current which flows in a power source circuit for a moment is needed.

Further, with the example disclosed in Japanese Patent Application Laid-Open No. 2001-117534 (paragraphs 0014 to 0016 and 0020 and FIGS. 6 and 8), at the time of applying of the reverse bias voltage, a problem that the reverse bias voltage has to be applied to the EL element E1 via the impedance between the drain D and the source S of the driving transistor Tr2 remains. In this case, the driving transistor Tr2 is set in such a way that a constant current drive is performed in order to guarantee a stable drive operation of EL elements, and therefore the impedance between the drain D and the source S is high.

Thus, even when the reverse bias voltage is applied between the common anode and the common cathode, since the driving transistor Tr2 having a high impedance lies, electrical charges accumulated in parasitic capacitances of EL elements at the time of the positive bias cannot be released instantly, and as a result a problem that the reverse bias voltage cannot be applied effectively to the EL element remains.

### SUMMARY OF THE INVENTION

The present invention has been developed as attention to the above-described technical problems has been paid, and it is an object of the present invention to provide drive devices and drive methods for a light emitting display panel in which a reverse bias voltage can be effectively applied to an EL element without decreasing the lighting time rate of the EL element.

A drive device according to the present invention which has been developed in order to carry out the object described above is, as described in claim 1, a drive device of an active matrix type display panel equipped with a plurality of light emitting elements which are arranged at intersecting positions between a plurality of data lines and a plurality of scan lines and each of which light emission is controlled at least via a lighting driving transistor, characterized by being constructed in such a way that a lighting mode in which a forward voltage is applied to the light emitting element and a reverse bias applying mode in which a reverse bias is applied to the light emitting element are selected, that the forward voltage is applied to the light emitting element via the lighting driving transistor in the lighting mode, and that the reverse bias is applied to the light emitting element via a reverse bias applying transistor in the reverse bias applying mode.

A drive method according to the present invention which has been developed in order to carry out the object described above is, as described in claim 9, a drive method of an active matrix type display panel equipped with a plurality of light emitting elements which are arranged at intersecting positions between a plurality of data lines and a plurality of scan lines and each of which light emission is controlled at least via a lighting driving transistor, characterized in that a lighting step of the light emitting element in which a forward voltage is applied to the light emitting element via the lighting driving transistor and an erase step in which the lighting driving transistor is cutoff so that the light emitting element is turned off are implemented, that a multi-gradation expression is realized based on a period of the lighting step and a period of the erase step, and that an operation that a reverse bias is applied to the light emitting element via a reverse bias applying transistor within the period of the erase step is implemented.

### BRIEF DESCRIPTION OF THE DRAWINGS

FIG. 1 is a connection diagram showing one example of a circuit structure corresponding to one pixel in a conventional active matrix type display panel;

FIG. 2 is a plan view schematically showing a state in which the circuit structure of each pixel shown in FIG. 1 is arranged in a display panel;

FIG. 3 is a connection diagram showing an example of a pixel structure of a three TFT form realizing digital gradation in which a drive device according to the present invention can be suitably adopted;

FIG. 4 is a connection diagram showing a first embodiment in which a reverse bias voltage can be applied to a light emitting element of the pixel structure shown in FIG. 3;

FIG. 5 is a connection diagram for explaining a data write state in the structure shown in FIG. 4;

FIG. 6 is similarly a connection diagram for explaining a data maintaining state;

FIG. 7 is similarly a connection diagram for explaining an erase state;

FIG. 8 is a connection diagram showing a second embodiment in which a reverse bias voltage can be applied to the light emitting element of the pixel structure shown in FIG. 3; and

FIG. 9 is a connection diagram for explaining an erase state in the structure shown in FIG. 8.

### DESCRIPTION OF THE PREFERRED EMBODIMENTS

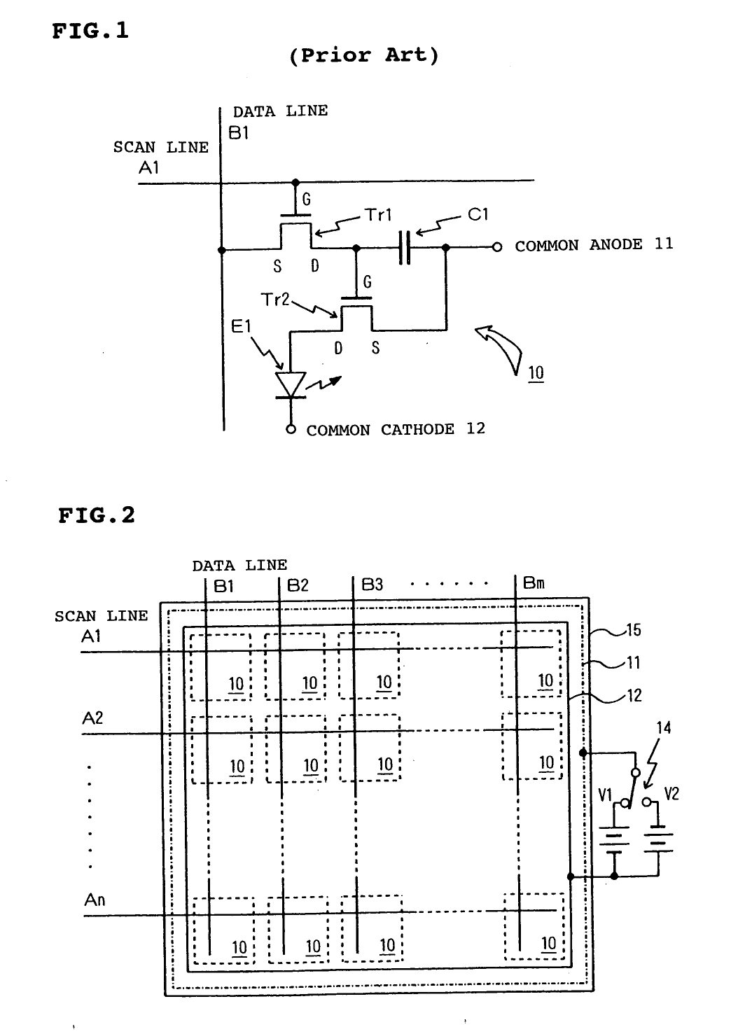

Drive devices for a light emitting display panel according to the present invention will be described below with reference to embodiments shown by the drawings. FIG. 3 shows an example of a pixel structure of a three TFT form which realizes digital gradation in which a drive device and a drive method according to the present invention can be adopted suitably. The lighting driving form for an EL element shown in this FIG. 3 is one called a simultaneous erasing method (SES; simultaneous erasing scan) which realizes a time division gradation expression and is constructed such that an erase transistor Tr3 is further added to the two TFTs structure shown in FIG. 1, that is, the structure composed of a write transistor Tr1 and a lighting driving transistor Tr2.

The source S of the write transistor Tr1 is connected to a data driver 21 via a data line, and the gate of this transistor Tr1 is connected to a scan driver 22 via a scan line. Similarly to the structure described with reference to FIG. 1, the drain D of the write transistor Tr1 and one terminal of an electrical charges maintaining capacitor C1 are connected to the gate G of the lighting driving transistor Tr2.

The source S of the driving transistor Tr2 is connected to the other terminal of the capacitor C1 and to an operation power source line Vcc. Further, the drain D of the driving transistor Tr2 is connected to the anode terminal of an organic EL element E1, and the cathode terminal of this organic EL element E1 is connected to a reference potential point (=0 volts).

The gate G of the erase transistor Tr3 is connected to an erase driver 23 via an erase line, and the drain D of this erase transistor Tr3 is connected to a common electrical potential portion of one terminal of the capacitor C1 and the gate G of the lighting driving transistor Tr2. The source S of the erase transistor Tr3 is connected to a connection point between the other terminal of the capacitor C1 and the source S of the lighting driving transistor Tr2, that is, to the operation power source line Vcc. In the structure shown in FIG. 3, only the driving transistor Tr2 is constituted by a p-channel type TFT, and other transistors are constituted by n-channel type TFTS.

In the pixel structure shown in FIG. 3, by supplying from the erase driver a gate voltage which turns the erase transistor Tr3 on in the middle of a lighting period of the EL element E1, electrical charges charged in the capacitor C1 can be erased instantaneously. Thus, the driving transistor Tr2 is brought to a cutoff state, and light of the EL element E1 can be turned off immediately. In other words, by controlling output timing of the gate-on voltage outputted from the erase driver 23, the lighting time of the EL element E1 is controlled, and thus a multi-gradation expression can be realized.

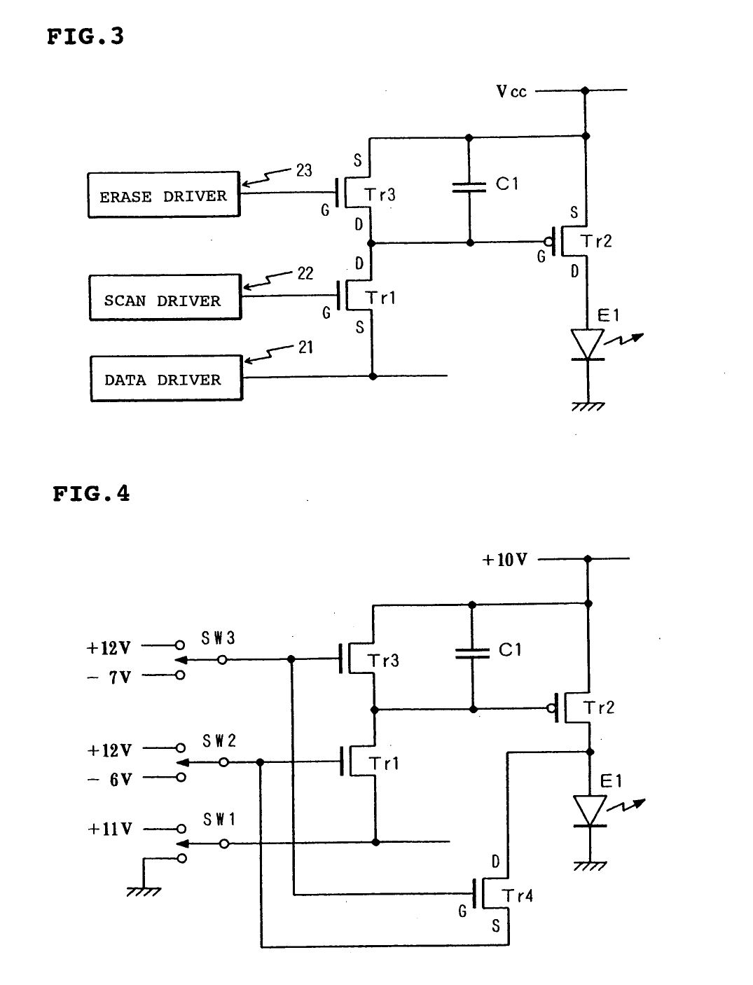

FIG. 4 shows a first embodiment in which a reverse bias voltage can be effectively applied to the EL element E1 of the pixel structure shown in FIG. 3. That is, in the structure shown in FIG. 4, a reverse bias applying transistor Tr4 by an n-channel type TFT is added to the pixel structure shown in FIG. 3. The drain D of this reverse bias applying transistor Tr4 is connected to the anode terminal of the EL element E1, the gate G thereof is connected to the gate G of the erase transistor Tr3, and the source S thereof is connected to the gate G of the write transistor Tr1.

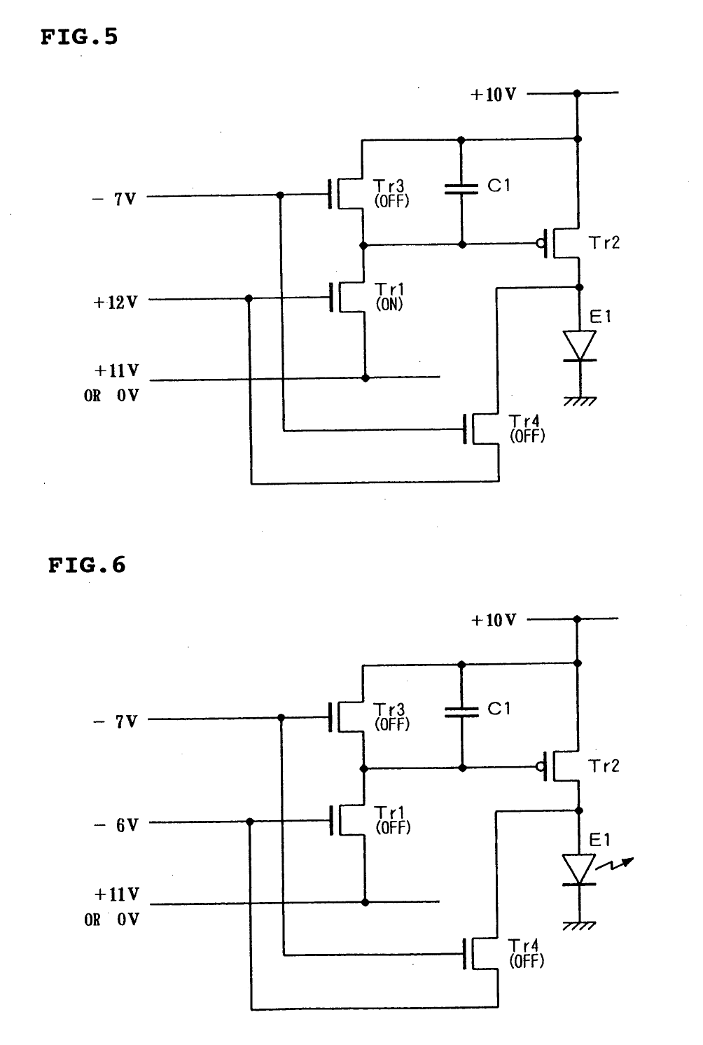

FIG. 4 shows a combination of electrical potentials respectively supplied from the data driver 21, the scan driver 22, and the erase driver 23, and by alternatively selecting respective switches SW1 to SW3 which equivalently show functions of the respective drivers, respective operation states described with reference to FIGS. 5 to 7 can be selected.

First, FIG. 5 shows set potentials of respective sections in a data write state. In this data write state, +11 volts or the reference potential (=0 V) is supplied from the data driver to the source S of the write transistor Tr1. At this time, an electrical potential of +12 volts is supplied from the scan driver to the gate G of the write transistor Tr1.

As a result, regardless of the source voltage (+11 volts or 0 volts) from the data driver, the write transistor Tr1 is brought to an ON state. Further, at this time, an electrical potential of −7 volts is supplied from the erase driver to the gate G of the erase transistor Tr3. At this time the Vcc that is the source voltage of the erase transistor Tr3 is +10 volts, and therefore the erase transistor Tr3 is brought to an OFF state.

Meanwhile, an electrical potential of +12 volts that is the gate voltage of the write transistor Tr1 is supplied to the source S of the reverse bias applying transistor Tr4, and an electrical potential of −7 volts that is the gate voltage of the erase transistor Tr3 is supplied to the gate G of the same transistor Tr4. Therefore, the reverse bias applying transistor Tr4 is brought to the OFF state.

Thus, the write transistor Tr1 allows current corresponding to the voltage from the data line supplied to the source S thereof to flow from the source S to the drain D, and thus the capacitor C1 is charged. In this embodiment, an electrical potential of 0 volts as data of the case where the EL element E1 is driven to be lit and an electrical potential of +11 volts as data of the case where the EL element E1 is not lit are supplied from the data driver to the source S of the write transistor Tr1.

In a series of operations described below, the case where the data for driving and lighting the EL element E1 is supplied from the data driver, that is, the case where the electrical potential supplied to the source S of the write transistor Tr1 is 0 volts, is exemplified and described. Accordingly, under the above-described conditions, by the ON operation of the write transistor Tr1, the terminal voltage of the gate side of the driving transistor Tr2 is brought to 0 volts, and the capacitor C1 is charged such that the voltage between both terminals thereof becomes 10 volts. Until this data write operation is completed, the driving transistor Tr2 is brought to the OFF state.

Next, FIG. 6 shows set potentials of respective sections in a data maintaining state. In this data maintaining state, an electrical potential of −6 volts is supplied to the gate G of the write transistor Tr1. As a result, the same transistor Tr1 is brought to the OFF state. Further, at this time, an electrical potential of −7 volts is supplied to the gate G of the erase transistor Tr3. Accordingly, the erase transistor Tr3 is also brought to the OFF state.

Thus, the electrical potential of −6 volts that is the gate voltage of the write transistor Tr1 is supplied to the source S of the reverse bias applying transistor Tr4, and the electrical potential of −7 volts that is the gate voltage of the erase transistor Tr3 is supplied to the gate G of the same transistor Tr4. Accordingly, the reverse bias applying transistor Tr4 also continues the OFF state.

Meanwhile, the terminal voltage of the gate side of the driving transistor Tr2 is held at 0 volts by the capacitor C1. Accordingly, the driving transistor Tr2 is brought to the ON state, and lighting driving current flows from the operation power source line Vcc (=10 volts) to the EL element E1 via the driving transistor Tr2, whereby the EL element E1 is brought to a light emitting state.

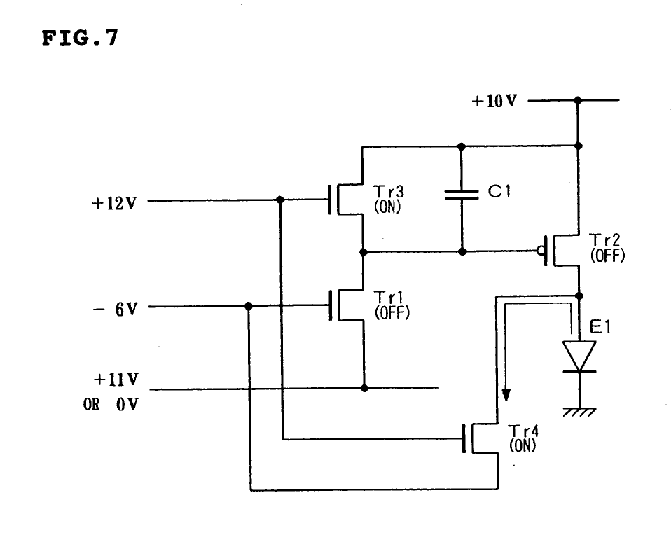

Here, as described above, in the case where a multi-gradation expression is performed, a gate voltage which turns the erase transistor Tr3 on is supplied from the erase driver in the middle of the lighting period of an EL element in one frame or one subframe. FIG. 7 shows voltage states of respective sections in an erase state in which the erase transistor Tr3 is turned on. That is, as shown in FIG. 7, +12 volts is applied to the gate G of the erase transistor Tr3, and as a result, the erase transistor Tr3 is brought to the ON state.

Accordingly, electrical charges of the capacitor C1 are instantaneously erased (discharged), and the gate voltage of the driving transistor Tr2 is brought to Vcc (=10 volts). Thus, the driving transistor Tr2 is brought to the OFF state, and the EL element E1 is immediately turned off.

At this time, an electrical potential of −6 volts that is the gate voltage of the write transistor Tr1 is supplied to the source S of the reverse bias applying transistor Tr4, and an electrical potential of +12 volts that is the gate voltage of the erase transistor Tr3 is supplied to the gate G of the same transistor Tr4. Accordingly, the reverse bias applying transistor Tr4 is brought to the ON state, and an electrical potential of −6 volts is supplied to the anode terminal of the EL element E1 via the reverse bias applying transistor Tr4. Therefore, a reverse bias voltage is effectively applied between the anode and cathode terminals of the EL element E1 via the reverse bias applying transistor Tr4 whose ON resistance value is small.

With the above-described embodiment, since the structure is that in which the gate of the reverse bias applying transistor Tr4 and the gate of the erase transistor Tr3 are connected and that the source of the reverse bias applying transistor Tr4 and the gate of the write transistor Tr1 are connected, in the erase state in which the erase transistor Tr3 is turned on, the state during its period is brought to a state in which the reverse bias voltage is applied to the EL element E1.

Accordingly, with the above-described structure, a reverse bias voltage can be reliably applied to the EL element E1 without particularly providing in the display panel a control line for controlling the reverse bias applying transistor Tr4 in such a way that the same transistor Tr4 is turned on/off. Furthermore, the state during the erase period provided for realizing the multi-gradation expression is brought to an applying mode of the reverse bias voltage in synchronism with the erase period, the reverse bias voltage can be applied without decreasing the lighting time rate (light emission duty ratio) of the EL element.

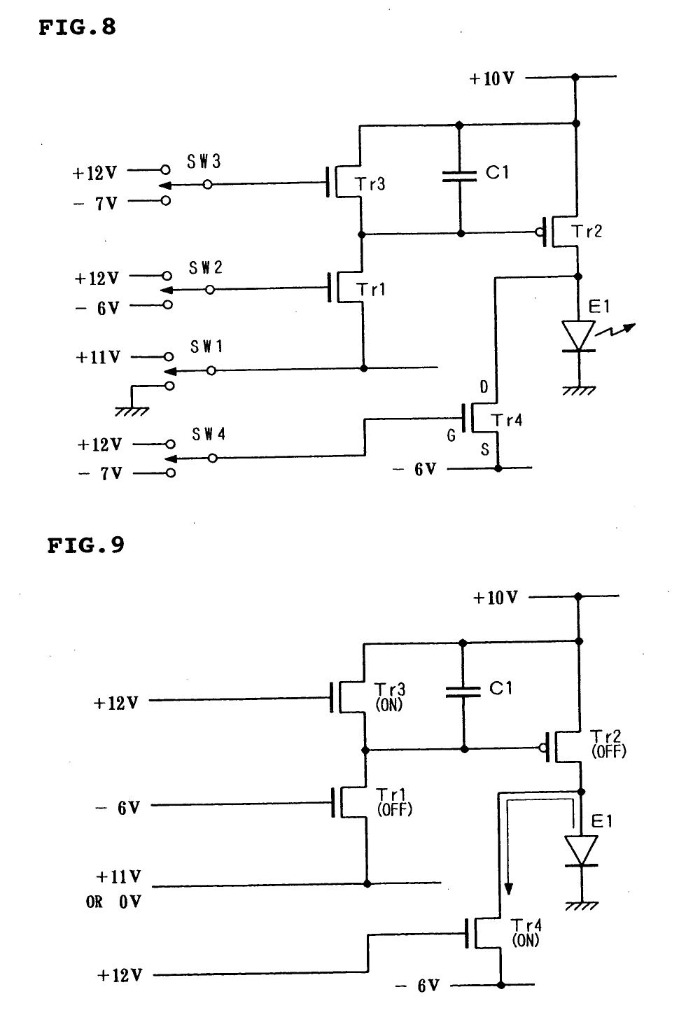

FIG. 8 shows a second embodiment in which a reverse bias voltage can be effectively applied to the EL element E1 of the pixel structure shown in FIG. 3. In this FIG. 8, portions corresponding to the structure shown in FIG. 4 which has already been described are denoted by the same reference numerals, and therefore detailed explanation thereof is omitted. In the embodiment shown in FIG. 8, in order to control the ON/OFF operation of the reverse bias applying transistor Tr4, a reverse bias applying driver equivalently shown by a switch SW4 is provided.

The drain D of the reverse bias applying transistor Tr4 is connected to the anode terminal of the EL element E1, and an electrical potential of -6 volts is applied to the source S thereof. The reverse bias applying drive requivalently shown by the switch SW4 is constructed in such a way that an electrical potential of +12 volts or −7 volts is selectively applied to the gate G of the reverse bias applying transistor Tr4.

Therefore, in the case where the electrical potential of +12 volts is applied to the gate G of the reverse bias applying transistor Tr4, the same transistor Tr4 can be controlled to be the ON state, and in the case where the electrical potential of −7 volts is applied to the gate G of the reverse bias applying transistor Tr4, the same transistor Tr4 can be controlled to be the OFF state.

FIG. 9 shows the erase state in which the erase transistor Tr3 is turned on, and this state is an operation state similar to that of FIG. 7 already described. In this embodiment, an ON/OFF control signal can be supplied independently to the gate G of the reverse bias applying transistor Tr4.

With this structure, interactions and effects similar to those of the first embodiment according to the present invention described with reference to FIGS. 4 to 7 can be obtained, and an operation that a reverse bias voltage is independently applied to the EL element E1 can be implemented at any one moment of time during the erase period in which the erase transistor Tr3 is turned on.

Although the above is described with reference to the embodiments in which the present invention is applied to the SES lighting driving method which realizes the time division gradation expression shown in FIG. 3, of course, the present invention can be applied to a pixel structure by a lighting driving method other than this method.

What is claimed is:

1. A drive device of an active matrix type display panel equipped with a plurality of light emitting elements which are arranged at intersecting positions between a plurality of data lines and a plurality of scan lines and each of which light emission is controlled at least via a lighting driving transistor, the drive device of a light emitting display panel characterized by being constructed in such a way that a lighting mode in which a forward voltage is applied to the light emitting element and a reverse bias applying mode in which a reverse bias is applied to the light emitting element are selected, that the forward voltage is applied to the light emitting element via the lighting driving transistor in the lighting mode, and that the reverse bias is applied to the light emitting element via a reverse bias applying transistor in the reverse bias applying mode.

2. The drive device of the light emitting display panel according to claim 1, characterized in that a write transistor for applying a gate potential of the lighting driving transistor is connected to the gate of the lighting driving transistor, and characterized by comprising an electrical charges maintaining capacitor which maintains the gate potential of the lighting driving transistor for a predetermined time.

3. The drive device of the light emitting display panel according to claim 1, characterized in that an erase transistor which operates to erase electrical charges of the capacitor at an arbitrary time is connected to a common electrical potential portion of the capacitor and the gate of the lighting driving transistor.

4. The drive device of the light emitting display panel according to claim 2, characterized in that an erase transistor which operates to erase electrical charges of the capacitor at an arbitrary time is connected to a common electrical potential portion of the capacitor and the gate of the lighting driving transistor.

5. The drive device of the light emitting display panel according to claim 3, characterized by being constructed in such a way that the reverse bias applying mode is selected in a period in which electrical charges of the capacitor are erased.

6. The drive device of the light emitting display panel according to claim 4, characterized by being constructed in such a way that the reverse bias applying mode is selected in a period in which electrical charges of the capacitor are erased.

7. The drive device of the light emitting display panel according to any one of claims 3 to 6, characterized in that an ON/OFF electrical potential of the erase transistor and an ON/OFF electrical potential of the reverse bias applying transistor are the same electrical potential.

8. The drive device of the light emitting display panel according to any one of claims 2 to 6, characterized in that an OFF electrical potential of the write transistor and an applying electrical potential of the reverse bias are the same electrical potential.

9. The drive device of the light emitting display panel according to claim 7, characterized in that an OFF electrical potential of the write transistor and an applying electrical potential of the reverse bias are the same electrical potential.

10. The drive device of the light emitting display panel according to any one of claims 2 to 6, characterized in that the gate of the reverse bias applying transistor and the gate of the erase transistor are connected and that the source of the reverse bias applying transistor and the gate of the write transistor are connected.

11. The drive device of the light emitting display panel according to claim 7, characterized in that the gate of the reverse bias applying transistor and the gate of the erase transistor are connected and that the source of the reverse bias applying transistor and the gate of the write transistor are connected.

12. The drive device of the light emitting display panel according to claim 8, characterized in that the gate of the reverse bias applying transistor and the gate of the erase transistor are connected and that the source of the reverse bias applying transistor and the gate of the write transistor are connected.

13. The drive device of the light emitting display panel according to claim 9, characterized in that the gate of the reverse bias applying transistor and the gate of the erase transistor are connected and that the source of the reverse bias applying transistor and the gate of the write transistor are connected.

14. The drive device of the light emitting display panel according to any one of claims 1 to 6, characterized in that the light emitting element is constituted by an organic EL element in which an organic compound is employed in a light emitting layer.

15. The drive device of the light emitting display panel according to claim 7, characterized in that the light emitting element is constituted by an organic EL element in which an organic compound is employed in a light emitting layer.

16. The drive device of the light emitting display panel according to claim 8, characterized in that the light emitting element is constituted by an organic EL element in which an organic compound is employed in a light emitting layer.

17. The drive device of the light emitting display panel according to claim 9, characterized in that the light emitting element is constituted by an organic EL element in which an organic compound is employed in a light emitting layer.

18. A drive method of an active matrix type display panel equipped with a plurality of light emitting elements which are arranged at intersecting positions between a plurality of data lines and a plurality of scan lines and each of which light emission is controlled at least via a lighting driving transistor, the drive method of a light emitting display panel characterized in that a lighting step of the light emitting element in which a forward voltage is applied to the light emitting element via the lighting driving transistor and an erase step in which the lighting driving transistor is cutoff so that the light emitting element is turned off are implemented, that a multi-gradation expression is realized based on a period of the lighting step and a period of the erase step, and that an operation that a reverse bias is applied to the light emitting element via a reverse bias applying transistor within the period of the erase step is implemented.

19. The drive method of the light emitting display panel according to claim 18, characterized in that the erase step of the light emitting element in which the lighting driving transistor is cutoff is implemented by an operation of the erase transistor which controls so that the gate potential of the lighting driving transistor is brought to a cutoff state.

20. The drive method of the light emitting display panel according to claim 19, characterized in that ON/OFF operations of the erase transistor and the reverse bias applying transistor are implemented synchronously.
